(19) United States
(12) Patent Application Publication
(10) Pub. No.: US 2018/0107914 A1
(43) Pub. Date: Apr. 19, 2018

(54) SYSTEM FOR TRACKING INVENTORY (USED OR NEW) USING ONE OR MORE OF A MULTIPLICITY OF IDENTIFICATION METHODS OPTIONALLY INCLUDING BUT NOT LIMITED TO RFIDS AND A DATABASE MANAGEMENT SYSTEM

(71) Applicant: Thomas J. ZIOLA, Menlo Park, CA (US)

(72) Inventor: Thomas J. ZIOLA, Menlo Park, CA (US)

(21) Appl. No.: 15/783,254

(22) Filed: Oct. 13, 2017

Related U.S. Application Data
(60) Provisional application No. 62/408,035, filed on Oct. 13, 2016.

(51) Int. Cl. G06K 19/10; G06K 7/10; G06K 19/06; H04L 9/32; G06K 19/077

(52) U.S. Cl. CPC G06K 19/10; G06K 7/10; G06K 19/07764; H04L 9/3278; G06K 19/06009

(57) ABSTRACT

A method may include obtaining a particular object. The method may also include affixing a tag to the particular object. The tag may include a first object identification and a second object identification. The second object identification may be different from the first object identification. The method may further include creating a record of the particular object in a database. The method may also include binding the first object identification and the second object identification to the record of the particular object in the database. The method may further include updating the record in the database based on a first identification of the particular object using the first object identification. The method may also include updating the record in the database based on a second identification of the particular object using the second object identification.

### CROSS-REFERENCE TO A RELATED APPLICATION

This application claims the benefit of and priority to U.S. Provisional Application No. 62/408,035, filed on Oct. 13, 2016, titled “SYSTEM FOR TRACKING RETURNED INVENTORY (USED OR NEW) USING RFIDS AND MULTIPLE OTHER OPTIONAL IDENTIFICATION METHODS AND A REPORTING SYSTEM DATABASE,” which is incorporated herein by reference in its entirety.

### FIELD

The embodiments discussed herein are related to electronic inventory management.

### BACKGROUND

The embodiments discussed herein are related to inventory management.

The loss of valuable products due to diversion and theft is a significant business challenge for many retail and industrial commercial businesses and government entities. This is a serious business challenge for both the handling of new products as well as the handling of returned products that may need to be organized, categorized, and handled differently depending on whether such objects become repaired, returned to the manufacturer, recycled for their component elements, or disposed of in other ways in the waste stream or buried in landfills. The financial impact of diversion and theft annually result in multiple tens of billions of dollars in lost commercial income. In addition, efficiently managing product inventories, which are handled and processed by many entities from the point of manufacture to the point of sale and in the aftermarket, can be extremely challenging and complex. Operating environments across enterprises that are involved in the sale, support, return, reprocessing, and recycling of commercial products are not seamlessly coordinated. Indeed, even for companies in the same industry, procedures and record keeping systems are not identical in each instance and systems are often incompatible with one another. Rather than being uniform, handling systems, identification systems, etc. are typically different at different stages, tracking and handling equipment is not uniform, procedures and processes vary from one entity to the next and from one stage in the lifecycle of a product to the next. This puts a premium on inventory tracking solutions that are reliable, secure, scalable, and robust, yet flexible enough to leverage different equipment configurations, data systems, and user-interfaces—each suitable for specific use cases—to accommodate these many and diverse real-world operating environments. In this context, a solution which can incorporate one or more of a multiplicity of identification and tracking techniques and data capture devices could be potentially highly impactful, effective, and attractive to enterprises that seek to track and manage product (new or used) across diverse operating environments.

In the case of returned consumer and commercial goods, many companies that process, handle, and manage returned goods that are otherwise destined predominantly to be recycled for their metal, rubber, plastic, and/or oil content, may try to balance their efforts to recycle product materials and by-products of their recycling efforts with attempts to find, identify, track, and responsibly handle returned products that can be refurbished or re-sold (if they meet acceptable criteria for re-use) to provide incremental income to their businesses and thus keep their businesses commercially sustainable.

Indeed, many recyclers and re-processors of products such as used tires, industrial equipment, parts, and components, used medical equipment, and other consumer or industrial products often operate on low profit margins and, to the extent a significant portion of their business model is dependent on recycling component materials, may be heavily impacted by volatile raw materials market prices. And particularly for such businesses, the ability to remarket re-useable or re-marketable products in various aftermarkets as an incremental source of revenue in addition to the repurposing of by-products (whether tire rubber, metal, or plastic) is important to their overall commercial success. This is especially the case today for products that have a high petroleum content (such as used or warrantied tires) but also extends to many other product categories as well. In the case of tires, for instance, a drop in the price of oil in any period can make it difficult for tire recyclers to commercially market ground-up tire rubber that might otherwise be used subsequently in road construction, surfaces of playgrounds and playing fields, building & insulation materials, power generation, and other uses, thus forcing more and more such recyclers to put used tire components and by-products into landfills, dumps, or even discard such materials in ways that could otherwise be ultimately damaging to our environment. When oil prices drop, there are fewer buyers for shredded rubber and plastics. A similar problem exists for metal recyclers. This puts a premium on inventory management systems that are especially cost-effective, readily adaptable, and do not require massive information technology investments or scores of highly trained professional personnel to operate.

Big integrated product manufacturers who produce large quantities of products for commercial sale may have, after considerable investment, developed tightly controlled manufacturing processes, manufacturing facilities, and operating environments. It is not unusual for large manufacturers to use relatively sophisticated inventory tracking systems at each stage of the production process. However, once products leave the direct control of manufacturers, unless they are managed, in turn, by sophisticated distributors and resellers who have themselves implemented tightly controlled materials handling processes, inventory tracking systems, and the like, problems arise. Shrinkage occurs, products get misplaced or diverted and—increasingly—high value/high margin products become attractive targets for substitution (replacing a valuable item with a similar item of less value) or counterfeiting (making fake copies of an authentic product, sometimes using inferior or substandard materials and components). Product substitution and counterfeiting are rampant and growing in many industries, including pharmaceuticals (especially outside the US), electronic components, electronic assemblies (even the FBI has been duped by counterfeit network servers), luxury goods, clothing, and a vast array of other consumer and industrial goods. Indeed, in parts of Africa, the majority of pharmaceuticals sold to consumers are counterfeit, and in many parts of the world it is not uncommon for counterfeit luxury goods and consumer electronics to be the norm rather than the exception.

The problem of diversion, shrinkage, and counterfeiting is massive, and scales in direct proportion to the value of the product and the ease with which it can be diverted, set aside, substituted, or copied without effective detection. Effective detection, in turn, depends in large measure on having robust, secure, cost-effective, and manageable (or at least easily administrable) ways to identify an object and then track it across its lifecycle, from the point of manufacture, through diverse sales channels and distribution networks, and ultimately post-sale and use, particularly in the case of products often returned and/or recycled.

The need for effective and cost-effective detection methods to mitigate diversion and counterfeiting is particularly acute in the case of returned and recycled products. Once a product is sold and used and then returned or dropped off for recycling, there is rarely a sufficiently attractive financial incentive to invest in sophisticated product identification and tracking systems. Compounding the challenge is the reality that tightly controlled materials handling procedures and processes are not common for returned goods and recycled products. Returned products may take a very circuitous route to their final destination, whether they are ultimately resold, refurbished, broken down into recyclable components, or put into the waste stream.

In addition to all the difficulties associated with managing the flow of used tires, used tire handlers need (a) to differentiate which tires came from which sites, and (b) identify, from all the tires they process, which reusable tires are from which original sites. This is a vexing problem. Typically there are no sophisticated digital systems for tracking these tires in their different states. Instead, used tires are typically picked up and placed in trucks by a diverse array of tire handlers, some of whom may be employed directly by the retail sites themselves, by independent trucking companies, or by large recyclers, as well as by part-time “jobbers” and floaters. Indeed, there may be combinations of such personnel who do this work. Furthermore, a truck can be loaded with tires from different retailers, under different brands and different ownership structures. And rather than use digital tracking technology, personnel may instead use clipboards, “manifests” that tally up total tire counts, or colored chalk or other hand-markings to identify tires from different sites. Manifests are based on hand counts and could be wrong, could include tires that came from sources other than the retail stores, and could also not include tires that have been diverted by store personnel prior to pick up by collections personnel. Chalk and other markings can rub off or be hard to read in hostile (wet, muddy, dark) environments. The problem is compounded because used tires are often combined into large piles that need to be quickly sorted and processed at large tire collection centers. A tire business would gain significant management control if it could identify which tires in a large collection of tires from different sites and suppliers were sourced from which sites. However, this is difficult to do today, and when it is done, any such information is so delayed that it is of little value so long after the fact.

In addition, there is a significant public safety concern in many categories of products that can also be addressed by deploying more effective tracking technologies and methods. If defective remarketed products can be traced back to their source, it can help assign responsibility for the marketing of defective products and thus provide an important incentive to reduce the introduction into the market of potentially hazardous remarketed products for which in many cases there may not be manufacturer warranties in effect. This achieves and/or realizes a significant public good to the benefit of many.

The subject matter claimed herein is not limited to embodiments that solve any disadvantages or that operate only in environments such as those described above. Rather, this background is only provided to illustrate one example technology area where some embodiments described herein may be practiced.

### SUMMARY

To address this important business issue as well as the environmental impact of re-processing returned products, a variety of identification and tracking systems, including but not limited to RFID technology can be used singly or in parallel with multiple other tracking and identification technologies to mitigate lost commercial revenues from the diversion, theft, or counterfeiting problems that many companies face in many product categories today. The ability to combine multiple techniques with a database system that can bind the different identification techniques together at an object level with data provided by different types of scanners, readers, and identification & tracking hardware, may also have the added benefit of being potentially capable of adapting to widely different operational conditions specific to particular product types and handling procedures and to different industries.

For example, it is possible to use an RFID in a store, but perhaps not feasible to use RFIDs in a collection center. Alternatively, for cost-control purposes and speed-of-processing purposes, it may be advisable to use another identification technique other than RFIDs, such as barcodes and barcode readers, in specific stages of the handling process. But if a first identification technique could be used in environment (a) but not environment (b) and a second identification technique can be used in environment (b) and the second identification technique for environment (b) can be linked or bound to the first identification technique for environment (a), it may be possible to have a system that can adapt to each environment and provide tracking and identification capabilities across a complex, multi-stage processing workflow. Someone experienced in the art upon learning of the technical features described herein could then select, combine, and adapt, using a more flexible approach that better aligns with business and operational constraints for particular markets.

Unique IDs of various types along with RFID technology of various types (multiple frequencies suited for different environments and PUF-enabled or not PUF enabled) can be deployed to improve handling procedures to improve the “yield” on reprocessed products, significantly reduce theft and diversion, and improve the overall profitability of the impacted businesses.

### BRIEF DESCRIPTION OF THE DRAWINGS

Example embodiments will be described and explained with additional specificity and detail through the use of the accompanying drawings in which:

FIG. 1 illustrates an example method of using a tag on an object;

FIG. 2 illustrates an example system of using multiple tags on multiple objects;

FIG. 3 illustrates an example embodiments of a multi-ID tag;

FIG. 4 illustrates an example embodiment of a tamper detection on a tag;

FIG. 5 illustrates an example embodiment of a database;

FIG. 6 illustrates another example embodiment of a database;

FIG. 7 illustrates an example system for object identification;

FIG. 8 illustrates an example method for object identification; and

FIG. 9 illustrates an example data capture device.

### DESCRIPTION OF EMBODIMENTS

Some embodiments described herein describe a method. A method may include obtaining a particular object. The method may also include affixing a tag to the particular object. The tag may include a first object identification and a second object identification. The second object identification may be different from the first object identification. The method may further include creating a record of the particular object in a database. The method may also include binding the first object identification and the second object identification to the record of the particular object in the database. The method may further include updating the record in the database based on a first identification of the particular object using the first object identification. The method may also include updating the record in the database based on a second identification of the particular object using the second object identification.

There are at least 3 aspects to the inventory challenge that together or individually can be addressed in hardware, software, and user interface designs that further facilitate the capacity of the solution to attain the goal of being flexible, cost-effective, and manageable, and also robust and functionally effective. One aspect is the design of tags that can be affixed to or embedded in products, such as but not limited to tires and other potentially re-marketable consumer and commercial or industrial products. These tags can incorporate multiple different identification methods, such as radio-frequency identification (RFID) (variously high frequency (HF), low-frequency (LF), or ultra high frequency (UHF) RFIDs), one dimensional or multi-dimensional barcodes, serial numbers, random numbers, icons, images, and the like, as well as a physical design that easily but durably allows the tag to be affixed to an object by a user/employee/staff person. Typically, such identifiers would include at least one unique identifier for each object, but may also involve a mix of non-unique identifiers as well (which could be subsequently analyzed to detect differentiated combinations of identifiers or other patterns and anomalies useful for management purposes). Furthermore, such tags can be specifically designed with anti-tamper or tamper detection characteristics, such characteristics including but not limited to scoring of the tag surface that can cause a tag to tear into parts if removed, highly effective adhesives that make it difficult to remove a tag from an object, or designs of tags that could cause a feature (such as an RFID) to no longer function properly.

There are a variety of ways that one or more identification techniques can be bound to one another for any given object. One method would be to bind, for example, an RFID identifier to a unique barcode on a tag at the point of assembly of the tag itself and store that resulting binding information in a database for later use, in some embodiments stored in a secure fashion. Another method would be to assemble the tag with, for example, a unique barcode at some other point in time after the point of manufacture, but before the tag is affixed to the object being tracked. This could be performed in a variety of ways including using a programmable device that can read both an RFID as well as a barcode to read the tag and then sequentially binding unique RFID data scans to their corresponding unique barcode numbers. Another method would be to perform this binding operation at the point of use of the tag, in other words on or about the time a tag is applied to an object to be tracked. Again, the binding operation could be executed by a device programmed to read an RFID and bind it to the unique barcode on the tag. Alternatively, in the case of non-RFID-equipped tags, other combinations could be implemented at point of manufacture of the tag or afterwards, such as binding of a unique serial number or a random number to a unique barcode. Furthermore, information about which tags were sent to which sites could be collected as tags are distributed and that data can be recorded and stored in a database for later lookup to confirm that certain tags were sent to certain destination for authorized use in the field. This sort of corroborating management information, if maintained in a database would furthermore facilitate the scheduling of shipments of tags to sites as well as the collection of objects from diverse locations.

A second aspect is having scanners and reader hardware that can read one or more of the identification methods of tags attached to or embedded in an object and perform useful functions involving tracking scanned/read objects. Such functions would include the ability to read or scan object identifier data and store the data or upload the data over a wired or wireless network to a data server which collects, assembles, and organizes data from that device and other devices. Optionally, the hardware may append additional information about the reader/scanner, the time of the scan, the location of the object at the time of the scan, the site the device may be is associated with in a database, the user of the device, and potentially other information about the object, such as the condition of the object, characteristics about the object (for example tread depth of a tire object, brand or model of the object, and other information associated with the object or the handler(s) of the objects). Furthermore, optionally, the scanner/reader can be designed to connect to a database, or alternatively query a locally stored database using an algorithm, to confirm the authenticity of a tag and the object to which it is affixed or embedded in. Such authentication methods could involve the use of physical unclonable function (PUF) circuitry in the design of an RFID device or use other secure or cryptographic methodologies. In the case of an RFID reader, the device may be equipped with appropriate RFID circuitry and a power source. Today a wide variety of mobile phones have such capability and in particular there are diverse Near-Field-Communication (NFC) equipped mobile phones that have this capability. And furthermore, such devices are programmable.

An easy to use user interface and a hardware & software design that has built-in error checking and re-try logic as well as multiple modes of operation (online, offline, real time, delayed, and batch) further increases the usability of the solution, its robustness, and its ability to adapt to different operating environments. For example, in some environments, a reader may not be able to communicate with a digital network due to the physical location of the reader or the presence of other electronic equipment. For such a situation, rather than use a wireless communication link, the device may store the scan and related data for subsequent upload. Also, in some embodiments, it may be beneficial for the user of the device to be able to get a simple visible text or image confirmation or an audible signal that a scan was successful or not successful. The device may also have a mechanism to identify the user, the name of the site where it is being used, the time of the scan, and other data. Furthermore, it may be beneficial to store data on a storage of the device, potentially for redundancy purposes if a network goes down or transmitted data is lost, for audit purposes, or for other purposes. Furthermore, in many situations, it may be beneficial for the scanner device to be able to record the physical location of the scan automatically. This could be accomplished with the use of mobile phone device (or a device tethered to a mobile phone) which could capture not only scan information as described above, but also GPS coordinates or cell tower location coordinates which could be associated with a scan event. Such location information could be useful in tracking inventory by location and be used to compare expected locations of scans with actual locations of scans to more effectively detect diversion events or other anomalies in the handling of products. Additionally, such devices may provide on-screen options or digital assistance for the operation or programming of the device, including mechanisms to load updated versions of software on the device over a network or via another digital device such as computer, pad, or another mobile device attached to the device.

A third aspect involves the way that diverse scan data from different devices being used in diverse operating environments can be collected, assembled, organized and analyzed to facilitate the tracking and management of inventory (new or used). Such a database can be maintained in an on-site server or be instantiated in an internet cloud configuration. Much of what follows is described in a cloud configuration, but someone practiced in the art could also adapt these concepts to an on-site server solution. With respect to the cloud-based design, a data system may organize scan capture and other object and usage data including the linkage of scan data to objects over time and across diverse scanning methods. For example, a unique RFID identifier may be associated with all scan and object data related to an object, regardless of identification technique. This would occur if, for example, a tire were scanned upon removal from a vehicle and the record of that scan included information about a barcode associated with the unique RFID identifier associated with the tire. Then, after the tire is collected from a retail store and transported to a collection center, in the event an RFID scan is not practical or possible, potentially due to the operating environment at a tire collection center, a barcode scan can be captured and transmitted to the cloud database. The initial RFID scan is then associated with the later barcode scan and both events are related to the individual object in each case. This concept of binding different events to a data record for an object can be extended to other identification data which can be similarly related to that object. Furthermore, for a practitioner skilled in database analytics, as large amounts of such data are assembled, it would be practical to apply various machine learning technology and algorithmic operations on the assembled data to further refine analyses; detect data discrepancies, product shortages, and other anomalies; guide shipping requirements; enhance product handling processes and procedures; and provide valuable predictive analytics on asset management concerns for management.

There are a number of advantages of this solution. For one, the object itself need not have expensive tracking information recorded locally in or on the object itself. Second, in the event one identification methodology fails or is impractical to apply for any reason, it may be possible to use another identification methodology in its place. Furthermore, changes to the handling processes can be implemented quickly, such as if an RFID reader fails and another scan method is available. Third, having multiple methods of identification, each of which can be in some way linked or related to an object provides system redundancy and, in the case of attempts to counterfeit, divert, or replace an object with an inferior object, additional ways to detect and mitigate against such occurrences.

Furthermore, scan event data can be used, if such data is made available in a reporting system, to track objects across a series of steps in their handling and processing. It is possible with such data to detect volumes, times, and frequency of scanning events, by site and by class of object. Daily, weekly, and seasonal reports can be generated. In some embodiments, the sources of such objects can be analyzed and even in the case where similar objects, such as tires, are combined in large groups from diverse sources, the underlying sources of each object can be determined. And in the case where returned products are sorted for potential re-marketing, which object was in which category (for instance identifying each object as re-marketable or not re-marketable) can be ascertained with a high degree of precision and minimal effort, which without such a system would be infeasible or impractical. Furthermore, scan event data can be correlated with sales and delivery data to detect individual cases as well as broader patterns of interest to management. Such correlating data could constitute digital signal data for instances of diversion, theft and counterfeiting of objects across a new product distribution network across various post-sale stages including product returns, re-marketing, refurbishing, and disposal.

The combination of these aspects, implemented singly or in various ways together, can greatly facilitate the management of new and used product inventory, help mitigate against theft, diversion, and counterfeiting, and improve the economics of enterprises, including especially enterprises involved in the handling and processing of products post-sale such as product returns, refurbs, warranty products, or products that may be suitable for re-marketing rather than disposal.

This system is illustrated in the attached slides that describe one such instance of a tracking system involving RFIDs for the purpose of identifying and tracking the handling of used tires at retail stores through to recycling centers where tires are graded for potential re-marketing in the used tire market. This example is presented to illustrate various aspects and benefits of embodiments of the invention described herein. The general principles of the methods and systems described herein can be applied to any of a variety of other retail, industrial, commercial, personal, or government settings.

The systems described herein can be also linked to a Point-of-Sale system or to invoices at the store level to further improve the efficiency of the overall workflow and facilitate audits of handling procedures and product theft and diversion activities at multiple stages in the handling process for such goods.

And as should be obvious from the above description, there are multiple ways an experienced practitioner in the field, upon learning of the details of the systems and methods described herein, could combine optional elements to achieve business and efficiency gains.

Furthermore, several types of anti-tamper, authentication, and tamper-detection features can be leveraged, individually or in combination, to confirm the identity of the object being tracked. PUF technology is one such highly secure technology for this purpose. But in addition, other options such as tamper-detect “scoring” of tags and/or labels can be used to detect attempts to circumvent the identification process or unauthorized changes to ways products are marked, tagged, or otherwise identified.

In some embodiments, the design of this solution involves a multiplicity of one or more identification techniques which singly or in combination facilitate the tracking, handling, and management of product inventory for post-sale, as well as potentially pre-sale operating environments in a robust and flexible manner which is especially well formulated for mixed-mode operation. One of the identification techniques referenced is the use of Radio Frequency Identification (RFID). RFIDs commonly use electromagnetic fields to facilitate the identification and tracking of tags attached to or embedded in objects. The tags contain electronically stored information. Passive tags and Active tags are common types of RFIDs. Passive tags collect energy from a nearby RFID reader's interrogating radio waves. Active tags have a local power source such as a battery and may operate at hundreds of meters from the RFID reader. But RFIDs come in many designs, and each has advantages and disadvantages in different operating environments. RFIDs typically store a variety of data, some of which may be programmable at the point of manufacture and assembly and other parts of which may be programmable in the field. RFIDs are commonly, though not exclusively, manufactured in the form of a “tag” which can be affixed to an object. In other cases, RFIDs can be embedded in an object. Also, RFIDs also typically include in their stored data a unique ID which is programmed and stored on-chip in non-volatile memory (though some configurations use volatile memory or battery-powered memory) either at or proximate to the time and place of manufacture and assembly, or alternatively at a time and place after the assembly process is complete. In most configurations, the programming is to a write-once/read many memory block. RFIDs receive radio frequency (RF) power signals from a reader/scanner, which excite and power the RFID chip to respond. Since most low cost RFIDs have no power, the RF signal from the reader/scanner provides the power that returns the response from the chip to the challenge transmitted by the reader/scanner. That protocol has various names but is commonly called a “challenge-response” protocol. In most use cases, the challenge-response protocol is conducted “in the clear” meaning that the challenge as well as the response is not encrypted. This is the most common design for low-cost RFIDs.

However, in certain circumstances, there is concern or cause to suspect that an adversary may attempt to read and thus copy the RFID challenge and/or response to expose a unique ID or response which is stored on the RFID and which is used to identify it and distinguish it from other RFIDs. Knowing a unique ID or a challenge-response pair could enable an adversary to replicate the ID or the challenge-response pair to create a functionally equivalent copy. And with such a copy, a chip could be duplicated, affixed to or embedded in an object, and not be readily detected by a reader/scanner which is attempting to distinguish one RFID from the next and certify that the object to which the RFID is attached or embedded is genuine, and not a copy, forgery, duplicate, counterfeit or the like. If successfully executed and not otherwise detected, it may allow an adversary to divert a genuine product, mask the true characteristics of the object to which it should be associated and substitute another, and thus effectively pose a threat that could defeat a tracking & identification system with serious business, as well as potentially harmful, consequences—particularly in the case of pharmaceuticals or products that have an important safety requirement (such as medical devices, machine components, or used tires).

There are a number of ways RFIDs have been designed to mitigate against counterfeiting and the like. One such security-enhancing method would be to use a cryptographic algorithm to mask the underlying unique ID of the chip and the challenge-response “handshake” between the chip and the reader (or the network service to which a reader may be connected). Use of an appropriate cryptographic protocol can be used to more securely “authenticate” and otherwise verify that the chip, tag, and by extension, the object to which it is affixed or embedded is genuine and not a fake, forgery, or unauthorized duplicate that has been copied or otherwise counterfeited by an adversary. There are several considerations around the use of crypto-equipped RFIDs. One is cost. Such devices tend to be more expensive than simpler RFID designs. They may require more circuitry

An alternative elegant alternative to a crypto-RFIDs are Physical Unclonable Funtion (PUF) enabled RFIDs. PUF designs leverage the natural manufacturing variation in chip circuitries and use this characteristic to facilitate ways to distinguish one chip/device from another. PUF-enabled RFIDs have the attraction of being relatively low cost (since they do not necessarily require large crypto circuitry) and can take advantage of non-volatile memory to generate electronic signals used for authentication, and not requiring a battery to power volatile memory storage of secret keys used in crypto designs. In addition, PUFs do not require the use of more expensive crypto-ready RFID readers.

Another way to afford a higher level of assurance that an article or product is genuine and not a counterfeit, copy, or forgery is to apply more than one identification methodology/technique. Combining an RFID ID along with another identification technology, such as a barcode for example, would imply that an attacker would have to defeat more than one authentication methodology to be assured of success in an attempt to forge or counterfeit a product, new or used. By combining more than one method of identification alone a more robust security solution is obtained. In the design of the system herein, the use of more than one factor to identify a tag and an object/product associated with that tag allows any one identification factor to be confirmed as being associated with another identification factor in a database that has stored information about more than one factor for any one object, thus providing a superior overall solution from a security standpoint.

In such a system, in one implementation, a solution that leverages a PUF circuit along with other identification methods provides the combination of a notably secure PUF authentication technology along with one or more other identification factors to create an especially secure multi-factor authentication model that would be superior from a security standpoint to a solution that merely used a traditional non-PUF or non-crypto enabled solution, thus delivering a significant innovation in the inventory tracking industry particularly as it pertains to post-sale products.

Furthermore, the use of more than one identification methodology has the additional significant practical and commercial benefit that, besides affording potentially a more secure solution for tracking objects, it also allows an object to be tracked in more than way, indeed in diverse ways, each befitting the particular environmental and operational environments involved in tracking the object during its handling and management. This is accomplished by linking or “binding” diverse types of identification factors in a data record for an object in a database that can be queried, analyzed, and, optionally, updated with additional information about the object as it is being handled and processed.

To illustrate this point, for example, if an object has an RFID identifier (PUF or non-PUF) associated with it as well as a barcode in a database, in environments where it is practical to perform an RFID scan, the results of an RFID scan data can be compared or verified against what is stored in a database for that object. Conversely, where an RFID scan is not feasible, but a barcode scan is feasible, a barcode scan can be performed, and the barcode scan can be matched to a barcode scan in a database which, in turn is linked to RFID identification data associated with the object. In fact, a single object in this illustration could move from RFID to barcode and back to RFID environments, all the while being identifiable as the same object even though the identification methodology varies across those diverse environments.

In one instance of such a design, a barcode number could be identical to a serial number printed in plain sight on a tag and “linked” or “bound” in a database. In another instance of such a design, a barcode number could be identical to a random printed number in plain sight on a tag. A number of combinations are possible and can be supported by a system designed to accommodate one or more of a multiplicity of different identifiers associated with a single object.

In another implementation, a barcode could be associated with, or linked or bound, to an RFID or other identifier at the point of manufacture and assembly (by programming the RFID or printing a number printed on the tag) and stored in a database, or alternatively it could be “linked” to an RFID at some point later after the point of manufacture and assembly of the tag, using a method that allows the database to be updated at a subsequent time. For instance, a tag can have both an RFID and a serial number in or on a tag affixed or embedded in an object, and later a user could read both the RFID and the number and communicate with a database to update the database so that these two numbers (the RFID ID and the barcode in this instance) are associated with the same tag and, by extension, the same object. Furthermore, a large number of diverse types of identification factors or identifiers could be associated with any given tag and object to which it is affixed or embedded. All or some of these diverse identification factors could be useful and practical in some subset of environments but perhaps not in others. This would allow a single object to be seen and reliably tracked in a tracking & management system as the same object across diverse environments, though being identified using different identification factors/identifiers across each of the different environments.

Furthermore, a system that has multiple different identifiers can be designed to be more robust. If, for example, one or more identifiers is missing in a database, the presence of at least one identifier can be used to “fill” a database for missing identifiers. In one instance of such a design, where an RFID is scanned, stored, and associated with an object, if the database has previously linked a barcode number or a serial number with that RFID, then even if the barcode or serial number is not read, it can be effectively filled into a table where a scan event is recorded, and then referenced at another time in the handling process.

Furthermore, such a system would also be capable of storing user-provided data about an object when a scan event occurs. This could be done by entering data into an RFID reader, such as a near field communication (NFC) equipped mobile phone which is capable of being programmed. A user scanning a tag could add information into the system about the condition of the object, take a picture, or provide a verbal commentary about the object and have that information stored in the database as well for later use downstream or to provide useful information for management or even an additional factor for authentication. In the case of a tire, the user could enter information about the make & model of the tire, the estimated amount of tread, or the dimensions of the tire, among other characteristics that would be beneficial to record in the system.

The accompanying diagrams and tables illustrate one version of a set of tables created by scans of RFIDs, barcodes, and collected GPS coordinates for scans, along with serial numbers associated with RFIDs by binding operations. Records in each table that have at least one common data field can be linked and correlated with one another and, by extension, to each table, allowing missing elements to be populated in the database, or alternatively, allowing the user to use an alternate identifier factor in diverse environments, but still enable the objects related to those identifiers to be linked. In addition, with each scan, as the time of the scan occurs and in the event GPS coordinates are captured, those fields can also be populated in the database. Subsequently, by analyzing scans by time, location, scanner ID, etc., it may be possible to track an individual item across multiple steps in a tracking & management system to effect business objectives in a cost-effective and robust manner with considerable flexibility.

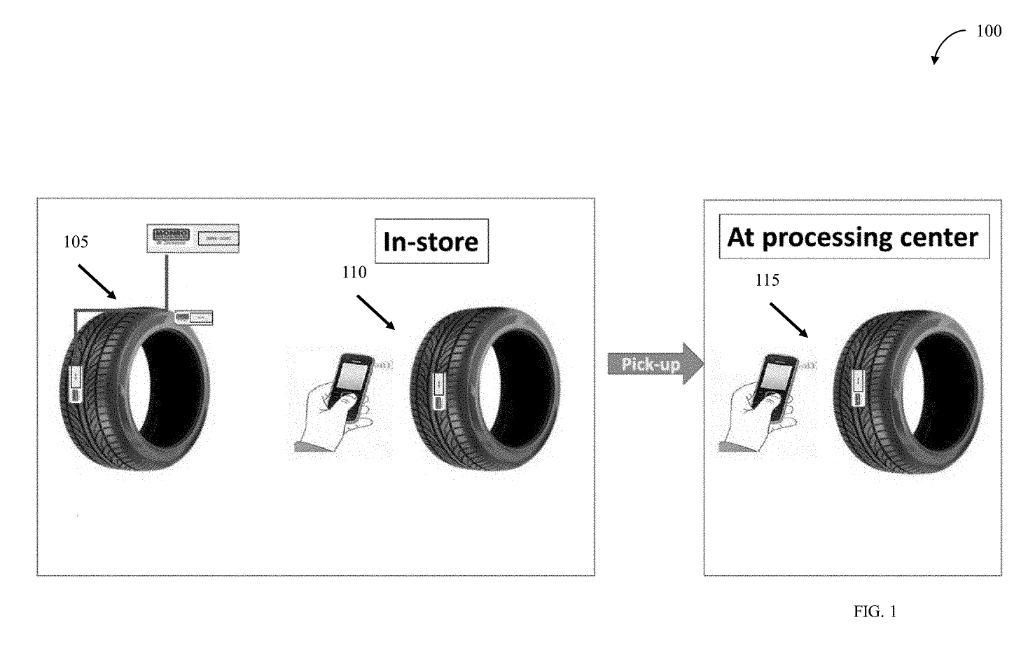

FIG. 1 illustrates an example method 100 of using a tag on an object. In particular, the method 100 depicts an example of a tire tagging and scanning process for tires received in retail outlets and intended for remarketing and/or recycling. In step 105, a tag may be attached to an object, such as a tire. In some embodiments, the tag may be attached to the sidewall or may be tread-facing. The tag may include multiple object identification markings and/or equipment, such as, for example, an RFID, a barcode, a serial number, or other markings. In some embodiments, the tag may be an RFID tag and the tag may be attached to the tire after removal.

In step 110, the tag may be scanned by a device such as a data capture device. The data capture device may be configured to read an RFID, a barcode, a serial number, or any other marking on the tag. For example, in some embodiments, the tag may be scanned by a cell phone equipped with an NFC.

In step 115, the tag may be scanned by a second device. For example, in some embodiments, the tag may be scanned by a cell phone equipped with an NFC. In some embodiments, the second device may be configured to read a different object identification marking on the tag. For example, in some embodiments, the device of step 110 may be configured to read an RFID and the device of step 115 may be configured to read a barcode.

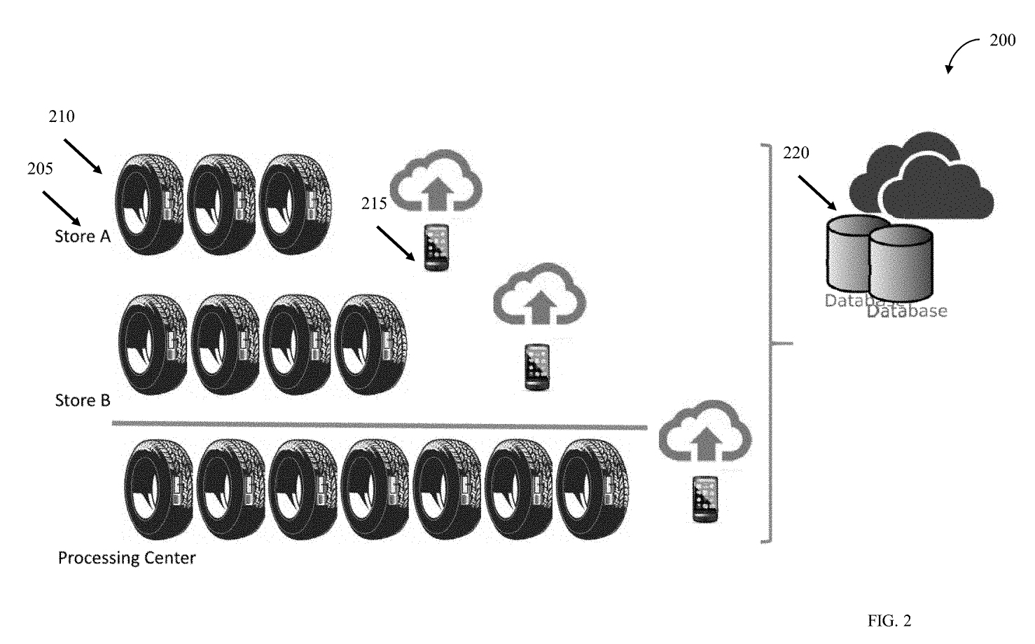

FIG. 2 illustrates an example system 200 of using multiple tags on multiple objects. For example, the system 200 may be a data capture and reporting system for used tires. The system 200 may include multiple tire handlers 205, for example Store A, Store B, and Processing Center. Each of the tire handlers 205 may include multiple tires 210. In some embodiments, tires 210 at each of the tire handlers 205 may include an affixed tag, which may include multiple object identifications. In these and other embodiments, the tires 210 and/or the affixed tags may be scanned or read by data capture device 215. In some embodiments, the data capture devices may include mobile telephones, tablet computers, barcode scanners, RFID readers, cameras, and other devices. Each of the tire handlers 205 may have their own data capture devices 215. In some embodiments, the data capture devices 215 of different tire handlers 205 may be different devices, may be configured to read different object identifications, and may be operated in different manners.

In some embodiments, each of the data capture devices 215 may be configured to transmit data about the tires 210 to a cloud database 220. In some embodiments, the cloud database 220 may be managed by a third party (e.g., not by the tire handlers 205). Alternatively, in some embodiments, the cloud database 220 may be managed by one or multiple of the tire handlers 205. The cloud database 220 may include information about the source of each tire 210, about the brand and model of each tire 210, about the location of each tire 210, or other information. For example, the cloud database 220 may include one or more unique tag IDs for each object; the date and time of each scan; and the store, geographic location, scanner identification, International Mobile Equipment Identify (IMEI)/Sub scriber identity module (SIM)/serial number of the tire and/or the device at each scan. In some embodiments, the data capture may be stored in the database via a wireless network, a cellular network, or another network. The database may include authentication and verification. The database may facilitate tracking tires 210 at one or more stages across the handling workflow.

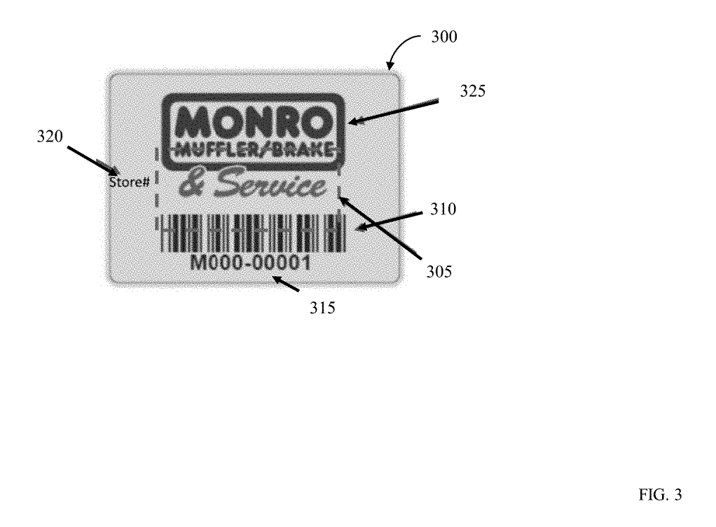

FIG. 3 illustrates an example embodiments of a multi-ID tag 300. The multi-ID tag 300 may include multiple optional components that may be linked or bound together. In some embodiments, the multi-ID tag 300 may include an RFID tag 305, a barcode 310, a serial number 315, a store number 320, and a company logo 325. Alternatively or additionally, in some embodiments, the multi-ID tag 300 may include other identification markers in place of or in addition to the RFID tag 305, the barcode 310, and the serial number 315.

In some embodiments, the RFID tag 305 may be attached to the label or embedded in the label. The RFID tag 305 may include single or dual frequency. The RFID tag 305 may be PUF enabled or not PUF enabled.

The barcode 310 may include a machine readable barcode, which may be unique per particular item or may be by product, stock keeping unit (SKU), item number, etc.).

In some embodiments, the store number 320 may indicate a location where the object to which the multi-ID tag 300 was purchased and/or serviced. Alternatively or additionally, the store number 320 may include a location number and/or a name.

In some embodiments, the individual id elements, including, for example, the store number, company, unique code or serial number, the product SKU, RFID ID, PUF authentication data, and alphanumeric code) may be “bound” or linked to one another in multiple ways to provide redundant means of identification in different operating/usage environments and/or multiple ways to identify a product with increased levels of confidence.

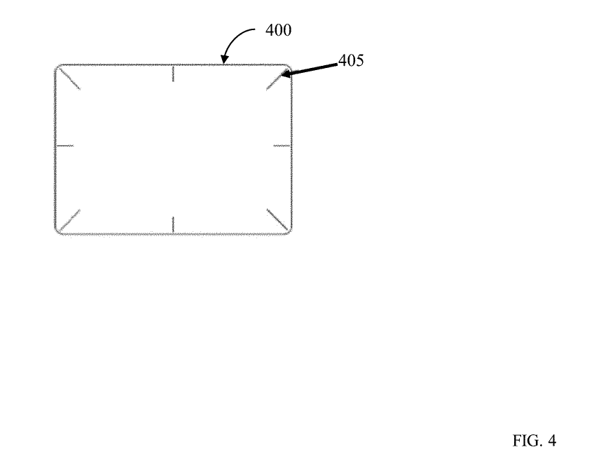

FIG. 4 illustrates an example embodiment of a tamper detection 405 on a tag 400. The tag 400 may be similar to the tag 300 of FIG. 3. In some embodiments, the tag 400 may be adhered to an object through the use of an adhesive, glue, or other material. In these and other embodiments, the tamper detection 405 may include scoring around edges of the tag 400. The tamper detection 405 may visibly split if the tag 400 is removed from an object to which it is adhered.

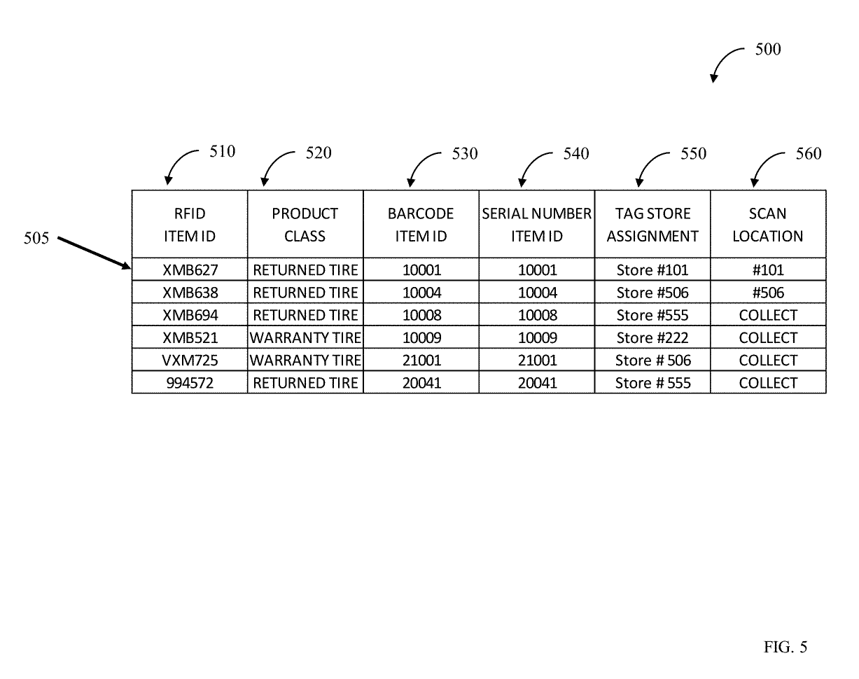

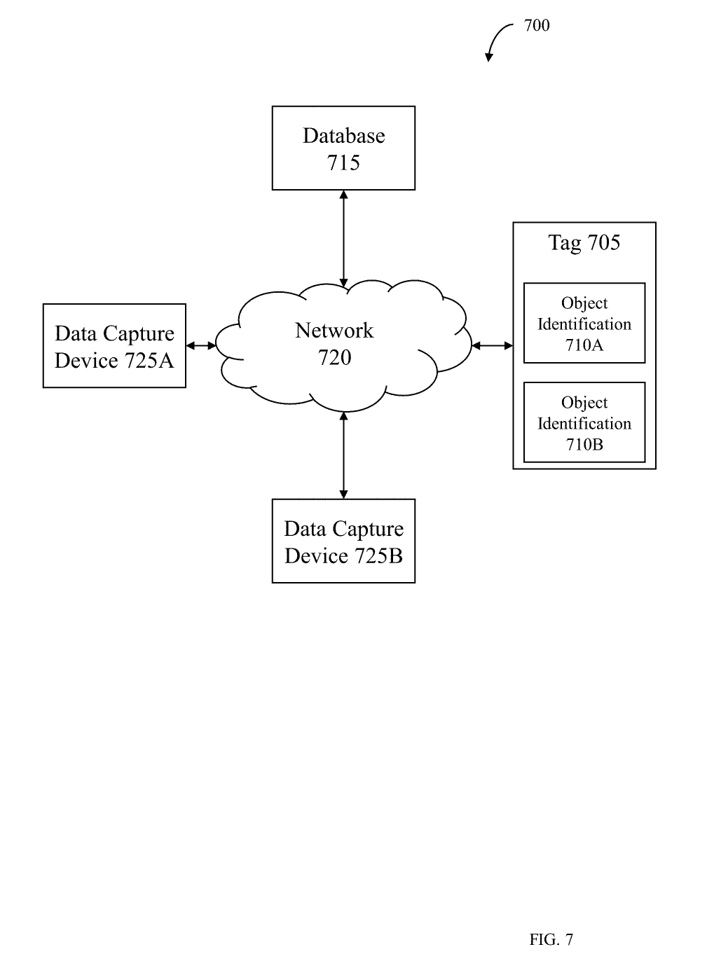

FIG. 5 illustrates an example embodiment of a database 500. The database 500 may be similar to the database 220 of FIG. 2 or the database 715 of FIG. 7. In some embodiments, the database 500 may be stored on a cloud storage. Alternatively or additionally, in some embodiments, the database 500 may be stored on a data capture device, on a local storage device, or on another data storage. In some embodiments, the database 500 may include fields 510, 520, 530, 540, 550, and 560 and records 505.

In some embodiments, the database may include multiple records 505. In these and other embodiments, each record 505 may correspond to a particular item. In some embodiments, each record 505 may include data in a variety of fields. For example, the 510 field may include an RFID Item ID for a tag affixed to the particular item. In some embodiments, the database 500 may also include a Product Class field 520, a Barcode Item ID field 530, a Serial Number Item ID field 540, a Tag Store Assignment field 550, and a Scan Location field 560.

In some embodiments, the RFID Item ID field 510, the Barcode Item ID field 530, and the Serial Number Item ID field 540 may bind multiple object identifications to the record 505 of a particular object. For example, a user may look up the particular object by searching for the associated RFID Item ID, Barcode Item ID, or Serial Item ID.

In some embodiments, the Product Class field 520 may include a condition or a description of the particular product associated with a record 505. For example, if the database is a database for tires, the Product Class field 520 may indicate that the particular tire is a returned tire, a warranty tire, a new tire, or any other class of tire.

In some embodiments, the Tag Store Assignment field 550 may indicate a store number, a store name, or other store identifier to which the particular product associated with a record 505 is assigned. For example, different stores may have sets of tags which are associated with the store. In some embodiments, the Tag Store Assignment field 550 may help track the location of a particular object or the origin of the particular object.

In some embodiments, the Scan Location field 560 may indicate the location of the most recent scan of the tag associated with a particular record.

In some embodiments, the database 500 may be presented as a single database. Alternatively or additionally, in some embodiments, the database 500 may be correlated or cross-linked with other databases or tables. For example, in some embodiments, there may be a separate Tag Shipment Table, which may correlate an ID of a record 505, such as the RFID, Barcode, or Serial Number, with a store number to which an item has been shipped.

In some embodiments, the database 500 may include additional fields, fewer fields, or different fields. For example, additional item ID fields may be included. Alternatively or additionally, in some embodiments, an item condition field may be added, which may allow a user of a scanner to add additional information related to the condition of a particular object at the time the object is scanned.

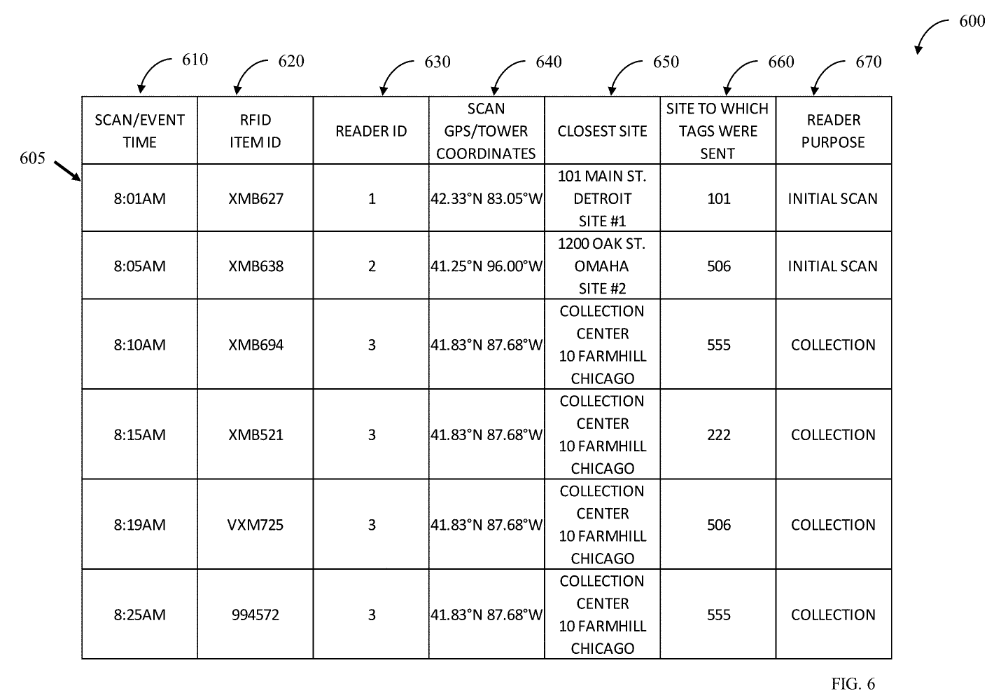

FIG. 6 illustrates another example embodiment of a database 600. The database 600 may be similar to the database 220 of FIG. 2 or the database 715 of FIG. 7. In some embodiments, the database 600 may be stored on a cloud storage. Alternatively or additionally, in some embodiments, the database 600 may be stored on a data capture device, on a local storage device, or on another data storage. In some embodiments, the database 600 may include fields 610, 620, 630, 640, 650, 660, and 670 and records 605.

In some embodiments, the database may include multiple records 605. In these and other embodiments, each record 605 may correspond to a particular item. In some embodiments, each record 605 may include data in a variety of fields. For example, the 620 field may include an RFID Item ID for a tag affixed to the particular item. In some embodiments, the database 600 may also include a Scan/Event Time field 610, a Reader ID field 630, a Scan GPS/Tower Coordinates field 640, a Closest Site field 650, a Site to Which Tags Were Sent field 660, and a Reader Purpose field 670.

In some embodiments, the RFID Item ID field 610 may include a unique RFID ID of a tag associated with a particular record 605. In some embodiments, the RFID Item ID may also be associated with other Item Identification IDs, as discussed above with respect to the database 500 of FIG. 5.

In some embodiments, the Scan/Event Time field 610 may include a time of a scan of a tag associated with a particular record 605. In some embodiments, the database 600 may include multiple Scan/Event Time fields 610, which may track multiple scans of the tag associated with a particular record 605. For example, in these and other embodiments, the database 600 may include a field for each scan of the tag. By using the scans, the history of the tag may be determined.

In some embodiments, the Reader ID field 630 may include an ID of a reader used to scan the tag associated with a particular record 605. For example, a first reader ID “1” may be associated with a reader that scanned the tag associated with a first record 605 and other reader IDs “2” and “3” may be associated with readers that scanned tags associated with other records 605.

In some embodiments, the Scan GPS/Tower Coordinates field 640 may include the geographic positioning coordinates of the reader at the time the scan took place. In some embodiments, this may help track the current location of a tag associated with a particular record 605 and/or help identify the last known location of a tag.

In some embodiments, the database 600 may also include a Closest Site field 650. In these and other embodiments, the closest site may be determined from the geographic positioning coordinates of the reader at the time of the scan. In these and other embodiments, the closest site may include an address, a name, or another identifier of the closest site to the geographic positioning coordinates.

In some embodiments, the Site to Which Tags Were Sent field 660 may include a site number, site name, site address, or other identifier of a site to which the tags associated with a particular record 605 were sent.

In some embodiments, the Reader Purpose field 670 may indicate a purpose of the scan. For example, the purpose of the scan may be an initial scan as a product to which a tag is affixed is returned to a store or place of purchase. Alternatively or additionally, the purpose of the scan may be a collection scan after a product has been shipped from the store to a collection location.

In some embodiments, readers may be assigned to sites and to purposes. For example, readers at a particular location may each be given a particular purpose. In some embodiments, the purpose may be determined using a lookup or using on-device programming. Alternatively or additionally, in some embodiments, a user of a reader may enter in a purpose of the scan. For example, a store may use readers for multiple purposes, such as to track sales, to categorize returns, and to send objects to collection locations.

In some embodiments, the database 600 may be presented as a single database. Alternatively or additionally, in some embodiments, the database 600 may be correlated or cross-linked with other databases or tables. For example, in some embodiments, there may be a separate Reader Assignment and Purpose Table, which may correlate an ID of a reader, with a store number to which an reader has been assigned and to a purpose of the reader.

In some embodiments, the database 600 may include additional fields, fewer fields, or different fields. For example, additional item ID fields may be included. Alternatively or additionally, in some embodiments, an item condition field may be added, which may allow a user of a scanner to add additional information related to the condition of a particular object at the time the object is scanned.

FIG. 7 illustrates an example system 700 for object identification. The system 700 may include a tag 705 including two object identifications 710, a database 715, a network 720, and two data capture devices 725.

In some embodiments, the tag 705 may be similar to the tag 300 of FIG. 3. The object identifications 710A and 710B may include RFID tags, barcodes, serial numbers, or any other identification. In some embodiments, the tag 705 may be affixed, adhered, embedded, or otherwise attached to a particular object. The identification of the particular object may be included in a record in the database 715, which may be a cloud database. The database record may also include the object identification 710A and the object identification 710B associated with the particular object.

The data capture device 725A may be configured to identify the particular object based on the object identification 710A but not based on the object identification 710B. For example, the object identification 710A may be an RFID tag and the object identification 710B may be a barcode. The data capture device 725A may be an RFID reader and may not be able to read barcodes.

Similarly, the data capture device 725B may be configured to identify the particular object based on the object identification 710B but not based on the object identification 710A. Continuing the above example, the data capture device 725B may be a barcode reader and may not be able to read RFID tags.

In some embodiments, the data capture devices 725 may be configured to enable a user to input additional data associated with a scanned tag 705. For example, a user may input information about the physical condition of the particular object associated with the tag 705. Alternatively or additionally, the data capture devices 725 may automatically include information related to the time of reading the tag 705, the location of the data capture devices 725 at the time of reading the tag 705, or other data associated with reading the tag 705. The information related to reading the tag 705 may be uploaded via the network 720 to the database 715. In this way, the database 715 may include information related to the history of the tag 705 and the corresponding particular object to which it is affixed, including locations of scans, times of scans, conditions, owners, repairs, refurbishments, etc. The database 715 may be searchable by multiple object identifications 710.

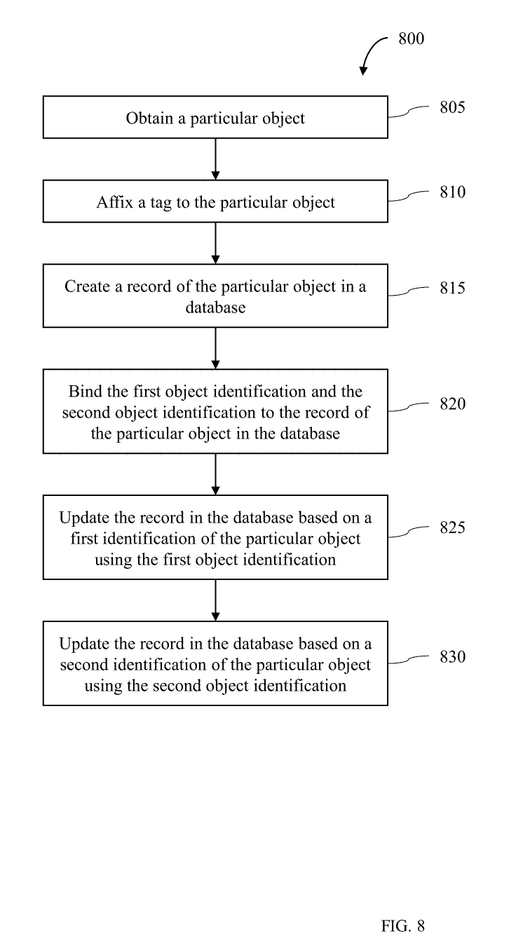

FIG. 8 illustrates an example method 800 for object identification. In step 805, a particular object may be obtained.

In step 810, a tag may be affixed to the particular object. The tag may include a first object identification and a second object identification. The second object identification may be different from the first object identification. In some embodiments, the tag may be embedded inside the particular object. In some embodiments, the tag may be adhered to a surface of the particular object.

In step 815, a record of the particular object may be created in a database.

In step 820, the first object identification and the second object identification may be bound to the record of the particular object in the database.

In step 825, the record in the database may be updated based on a first identification of the particular object using the first object identification. In some embodiments, updating the record in the databased may include updating the record in the database with a time and a location of the first identification. In some embodiments, updating the record in the database may include updating the record in the database with an identification of a device that performed the first identification and physical characteristics of the particular object.

In step 830, the record in the database may be updated based on a second identification of the particular object using the second object identification.

One skilled in the art will appreciate that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

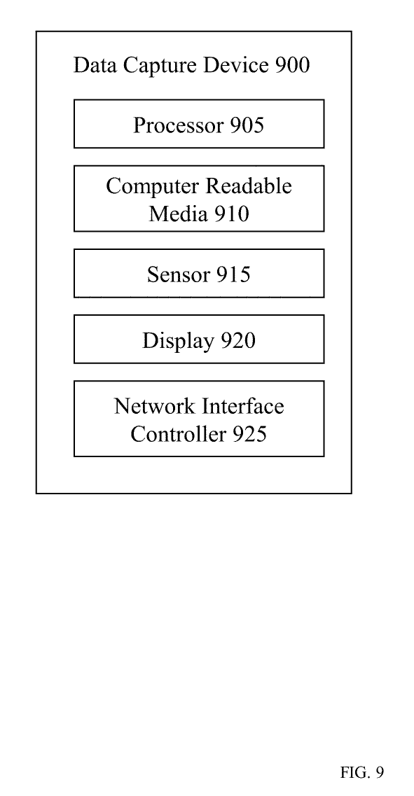

FIG. 9 illustrates an example data capture device 900. The data capture device 900 may include one or more processors 905, computer readable media 910, sensors 915, displays 920, and network interface controllers 925.

The processors 905 may include any microprocessor, a digital signal processor, application-specific integrated circuit, field-programmable gate array, or any other circuity configured to interpret and/or execute code instructions or process data.

The computer readable media 910 may include non-transitory computer-readable storage media including Random Access Memory, Read-Only Memory, Compact Disc Read-Only Memory, Electrically Erasable Programmable Read-Only Memory, other magnetic disk storage, other optical disk storage, flash memory devices, solid state memory devices, or other storage media that may be used to store computer instructions.

The sensors 915 may include RFID readers, barcode scanners, cameras, location sensors, and other sensors configured to read object identifications on tags.

The display 920 may be configured to display messages, images, text, or other graphics generated by executing code instructions on the processor 905.

The network interface controllers 925 may include any component, device, or system that is configured to transmit or receive information from other devices. In some embodiments, the network interface controller may include wireless controllers, wired controllers, near field communication controllers, and other controllers. The data capture device 900 may be configured to communicate with networks, such as the network 520 of FIG. 5 using the network interface controllers 925. Alternatively or additionally, in some embodiments, the data capture device 900 may be configured to communicate with other devices, which may communicate with the network 520. The network interface controllers 925 may be configured to permit data exchange between the data capture device 900 and other devices.

In one example embodiment, a system may use multiple of object identification methods, including at least one of RFIDs (UHF, HF, LF) with unique IDs or PUF authentication, barcodes (1, 2 or 3 dimensional), serial numbers, random numbers, and visual markings. The object identification methods may be used singly or in combination to capture data about devices (either directly or from tags affixed to the object) and to track inventory over a product's lifecycle.

In another example embodiment, a system may include tags that may be affixed to objects. The tags may include multiple identification methods. The system may also include data capture devices, such as Near-Field-Communication (NFC) equipped mobile phones or tablets, other types of commercial RFID readers, barcode readers, or other image capture devices (including devices which can do one or more of such types of scans, such as both barcode and RFID). The data capture devices may alternatively capture data locally on the device, send the scan event data over a network to a cloud-based data server, or provide the data to be downloaded from the data capture device or sent digitally to another electronic device by physical or local wireless network (e.g., Wi-Fi, Bluetooth, or NFC) for subsequent transmission to a cloud-based data server.

In another example embodiment, a system may include mobile devices to read RFIDs, barcodes, or other optical identifiers; barcode readers to read barcodes; or other types of scanning devices to capture scan event data associated with an object or a class of objects. The devices may optionally process the scan data locally on the device itself, store the data for later use, or transmit the data to an on-site or cloud database for processing and analysis.

In another example embodiment, a data capture device, such as a mobile phone, may be configured to scan and capture barcode data or RFID data from a tag or object. The data capture device may include user interface software that provides the user with signal feedback (audible sounds, on-screen images, icons, or text, or vibration) to indicate to the user if the scan or data capture was successful and instructions in the scan data capture event it was unsuccessful.

In another example embodiment, a data capture device may be programmed to “authenticate” the data that is captured so that the data can be verified as matching or otherwise corresponding to what is in a database. In some embodiments, the data capture device may be configured to execute an authentication command with an authentication server, such as, for example, a PUF authentication or a cryptographic algorithm authentication.

In another example embodiment, a data capture device user interface may allow a user to enter additional information about the object being tracked, such as, for example, the name or brand of the object, the size, weight, color or other physical characteristics of the object, the source of the object such as an order number associated with the object or other physical characteristics, including the physical condition of the object or some aspect of its appearance, or attach a photo or video of the object in situ or in use, which can be attached and correlated with the object in a cloud-based data repository.

In another example embodiment, a system may be configured to authenticate the scan data. The authentication may be in the form of a lookup of an ID against a central database, a secure PUF, or a secure cryptographic authentication method.

In another example embodiment, a system may be configured to use hardware and software to bind different identifiers for an object to a record of that object. The binding may occur at point of assembly of a tag or at some subsequent time after assembly of the tag.

In another example embodiment, a system may create a record of each scan event. The record may include information about the scan event, for example device/reader ID, item ID (captured by the digital scanning device from one or more of a barcode, an RFID, or other optical identification), time, location, store name/identifier, and username/identifier. The information may be stored locally or subsequently uploaded after scanning to a virtual database cloud storage system.

In another example embodiment, a reporting system may collect scan event data and allow the creation of reports of scan event data. The reports may be categorized by site, time, and other categories. The reporting system may display trends and provide analytic insights with algorithmic analysis. The reporting system may also facilitate comparison of shipments of tags to sites and data about tires to help detect anomalies in the handling of objects.

In another example embodiment, a system may use multiple object identification methods as described above applied to the tracking and management of tires returned to stores for recycling, warranty processing, or re-marketing.

Terms used herein and especially in the appended claims are generally intended as “open” terms (e.g., the term “including” should be interpreted as “including, but not limited to,” the term “having” should be interpreted as “having at least,” the term “includes” should be interpreted as “includes, but is not limited to,” and/or others).

The following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, and/or others

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A system to track inventory, comprising:
a tag including a first object identification and a second object identification, the first object identification different from the second object identification and the tag configured to be attached to an object;
a database correlating the first object identification and the second object identification; and
a data capture device communicatively coupled with the database and configured to read the first object identification.

2. The system of claim 1 wherein the first object identification includes radio-frequency identification (RFID) and wherein the second object identification includes an optical identifier.

3. The system of claim 2, wherein the RFID includes a physical unclonable function (PUF).

4. The system of claim 2, wherein the optical identifier includes one of: a barcode, a serial number, a random number, and a visual marking.

5. The system of claim 1, wherein the first object identification includes RFID and wherein the data capture device includes a near-field communication chip configured to read the RFID.

6. The system of claim 1, wherein the data capture device includes one of: a mobile telephone, a tablet computer, an RFID reader, a barcode reader, and a camera.

7. The system of claim 1, wherein the database includes a plurality of sets of positioning coordinates, each set of positioning coordinates of the plurality of sets of positioning coordinates associated with a different scanning event of the first object identification or the second object identification.

8. A data capture device, comprising:
a sensor configured to read object identifications;
a network interface controller;
a display;
one or more non-transitory computer-readable media that include computer-readable instructions stored thereon; and
one or more processors communicatively coupled to the one or more computer-readable media, the sensor, the network interface controller, and the display, the one or more processors configured to, in response to execution of the instructions, perform or control performance of operations comprising:
read an object identification using the sensor;
identify a particular object based on reading the object identification;
provide an indication of successful identification of the particular object using the display; and
provide data on the identification of the particular object to a database using the network interface controller.

9. The data capture device of claim 8, wherein the sensor includes one of: an RFID reader, a barcode reader, and a camera.

10. The data capture device of claim 8, further comprising a positioning sensor communicatively coupled with the one or more processors and wherein the operations further comprise:
identifying a location of the data capture device when the object identification is read using the positioning sensor; and
providing the location of the data capture device to the database using the network interface controller.

11. The data capture device of claim 8, further comprising a human interface device communicatively coupled with the one or more processors and wherein the operations further comprise:
receiving input from a user via the human interface device associated with the particular object; and
providing the input of the user to the database using the network interface controller.

12. The data capture device of claim 11, wherein the input includes one or more of: a size of the particular object, a weight of the particular object, a color of the particular object, and a physical condition of the particular object.

13. The data capture device of claim 11, wherein the input includes one or more of: physical characteristics of the particular object, a brand identification of the particular object, and a source of the particular object.

14. The data capture device of claim 13, wherein the input includes a source of the particular object and wherein the source of the particular object includes an order number of an order including the particular object.

15. The data capture device of claim 8, wherein the operations further comprise authenticating the object identification using one of PUF authentication and a cryptographic algorithm.

16. A method to track inventory, comprising:
obtaining a particular object;
affixing a tag to the particular object, the tag including a first object identification and a second object identification, the second object identification different from the first object identification;
creating a record of the particular object in a database;
binding the first object identification and the second object identification to the record of the particular object in the database;
updating the record in the database based on a first identification of the particular object using the first object identification; and
updating the record in the database based on a second identification of the particular object using the second object identification.

17. The method of claim 16, wherein affixing the tag to the particular object includes embedding the tag inside the particular object.

18. The method of claim 16, wherein affixing the tag to the particular object includes adhering the tag to a surface of the particular object.

19. The method of claim 16, wherein updating the record in the database based on the first identification includes updating the record in the database with a time and a location of the first identification.

20. The method of claim 16, wherein updating the record in the database based on the first identification includes updating the record in the database with an identification of a device that performed the first identification and physical characteristics of the particular object.
